(19) United States
(12) Patent Application Publication
(10) Pub. No.: US 2014/0333513 A1
(43) Pub. Date: Nov. 13, 2014

(54) ORGANIC LIGHT EMITTING DISPLAY DEVICE AND DRIVING METHOD THEREOF

(71) Applicant: Samsung Display Co., Ltd., Yongin-City (KR)

(72) Inventors: So-Young PARK, Yongin-City (KR); Dong-Hwan LEE, Yongin-City (KR); Seung-kyun HONG, Yongin-City (KR); In-Soo LEE, Yongin-City (KR)

(73) Assignee: Samsung Display Co., Ltd., Yongin-City (KR)

(21) Appl. No.: 14/099,191

(22) Filed: Dec. 6, 2013

(30) Foreign Application Priority Data
May 7, 2013 (KR) 10-2013-0051515

(51) Int. Cl. G09G 3/32

(52) U.S. Cl. CPC G09G 3/3266; G09G 3/3275
USPC 345/76

(57) ABSTRACT

A display unit includes data lines, first scan lines, second scan lines, light emission control lines and pixels, where each pixel is connected to a corresponding data line of the data lines, a corresponding first scan line of the first scan lines, a corresponding second scan line of the second scan lines and a corresponding light emission control line of the light emission control lines; a scan driver configured to transfer first scan signals to the first scan lines, and transfer second scan signals to the second scan lines, respectively; a data driver configured to transfer data signals to the data lines, respectively; and a light emission control driver configured to transfer light emission control signals to the light emission control lines, respectively, in which the scan driver transfers the second scan signals substantially simultaneously to at least two second scan lines among the second scan lines.

This application claims priority to Korean Patent Application No. 10-2013-0051515, filed on May 7, 2013, and all the benefits accruing therefrom under 35 U.S.C. §119, the content of which in its entirety is herein incorporated by reference.

### BACKGROUND

(a) Field

Exemplary embodiments of the invention relate to an organic light emitting diode display and a driving method thereof.

(b) Description of the Related Art

A display device generally includes a display area, in which a plurality of pixels is disposed on a substrate in a matrix form, and a scan line and a data line, which are connected to the pixels and selectively apply a data signal to each pixel to display an image.

The display device may be classified into a passive matrix type light emitting display device and an active matrix type light emitting display device according to a driving mode of the pixel. The active matrix type light emitting display device, which emits light selected for each unit pixel based on resolution, contrast and operation speed, is widely used.

The active matrix type display device may be used as a display device of a personal computer, a portable phone, a portable information terminal such as a personal digital assistant (“FDA”), and the like or monitors of various information devices, and may include an liquid crystal display (“LCD”) using a liquid crystal panel, an organic light emitting diode display using an organic light emitting element, a plasma display panel (“PDP”) using a plasma panel, and the like. Among such an active matrix type display device, the organic light emitting diode display may include a data driver for transferring data signals to a plurality of data lines, a scan driver for sequentially transferring scan signals to a plurality of scan lines, and a plurality of pixels connected to the plurality of scan lines and the plurality of data lines. Each pixel includes an organic light emitting diode (“OLED”) and a driving transistor for controlling a current amount supplied to the organic light emitting diode.

### SUMMARY

In a conventional organic light emitting diode display including a compensation circuit for compensating a threshold voltage difference of a driving transistor in each pixel, a response speed of the driving transistor may vary when an image is displayed according to a data signal having a large luminance difference between a previous frame and a current frame. Particularly, when luminance is changed from black to white, the response speed may be substantially delayed, and a ghosting, e.g., a shadow when a text is scrolled on a screen at a rapid rate, may occur.

In exemplary embodiments of the invention relate to an organic light emitting diode display and a driving method thereof, in which the ghosting due to a threshold voltage difference compensation of the driving transistor and a response speed is effectively prevented.

An exemplary embodiment of the invention provides an organic light emitting diode display including: a display unit including a plurality of data lines, a plurality of first scan lines, a plurality of second scan lines, a plurality of light emission control lines and a plurality of pixels, where each of the plurality of pixels is connected to a corresponding data line of the plurality of data lines, a corresponding first scan line of the plurality of first scan lines, a corresponding second scan line of the plurality of second scan lines and a corresponding light emission control line of the plurality of light emission control lines; a scan driver configured to transfer a plurality of first scan signals to the plurality of first scan lines, and transfer a plurality of second scan signals to the plurality of second scan lines, respectively; a data driver configured to transfer a plurality of data signals to the plurality of data lines, respectively; and a light emission control driver configured to transfer a plurality of light emission control signals to the plurality of light emission control lines, respectively, in which the scan driver transfers the second scan signals substantially simultaneously to at least two second scan lines among the plurality of second scan lines.

In an exemplary embodiment, the plurality of pixels includes first and second pixels connected to two first scan lines of the plurality of first scan lines, respectively, and commonly connected to a same second scan line of the plurality of second scan lines.

In an exemplary embodiment, the first and second pixels may be commonly connected to a same light emission control line of the plurality of light emission control lines.

In an exemplary embodiment, the scan driver transfers a second scan signal of the plurality of second scan signals to have an activating period which overlaps an activating period of a corresponding light emission control signal of the plurality of light emission control signals for a predetermined time in a frame.

In an exemplary embodiment, the scan driver may activate a second scan signal of the plurality of second scan signals in a frame before a corresponding first scan signal of the plurality of first second signals is activated in the frame.

In an exemplary embodiment, each of the plurality of pixels may include an organic light emitting diode; a driving transistor configured to transfer a driving current to the organic light emitting diode based on the corresponding data signal; a capacitor including a first electrode connected to a first power voltage applying terminal and a second electrode connected to a gate electrode of the driving transistor; a switching transistor configured to transfer the corresponding data signal to the second electrode of the capacitor based on the first scan signal; and an initial transistor configured to transfer an initial voltage to the second electrode of the capacitor based on the second scan signal.

In an exemplary embodiment, each of the plurality of pixels may further include a threshold voltage compensation transistor which diode-connects the driving transistor according to the first scan signal.

In an exemplary embodiment, each of the plurality of pixels may further include a first light emission control transistor which connects the first power voltage applying terminal and the driving transistor based on the light emission control signal; and a second light emission control transistor which connects the driving transistor and the organic light emitting diode based on the light emission control signal.

Another exemplary embodiment of the invention provides a driving method of an organic light emitting diode display including substantially simultaneously transferring a light emission control signal of a plurality of light emission controls signals to first and second pixels of the organic light emitting diode display, which are disposed adjacent to each other and connected to different first scan lines of a plurality of first scan lines of the organic light emitting diode and to a same second scan line of a plurality of second scan lines of the organic light emitting diode, where the plurality of first scan lines transmits a plurality of first scan signals of the organic light emitting diode, and the plurality of second scan lines transfers a plurality of second scan signals of the organic light emitting diode; and substantially simultaneously transferring a second scan signal of the plurality of second scan signals to the first and second pixels, where the first and second pixels are connected to a data diver of the organic light emitting diode and receive a data signal, and the first and second pixels receive an initial voltage for an activating period of the second scan signal in a frame.

In an exemplary embodiment, the driving method of an organic light emitting diode display may further include emitting light corresponding to a data signal of a previous frame written in each of the first and second pixels based on the light emission control signal.

In an exemplary embodiment, the substantially simultaneously transferring the second scan signal may include transferring the second scan signal to have an active period which overlaps an activating period of the light emission control signal for a predetermined time in the frame.

In an exemplary embodiment, the driving method of an organic light emitting diode display may further include emitting light by the first and second pixels in response to the initial voltage.

In an exemplary embodiment, the driving method of an organic light emitting diode display may further include sequentially transferring different first scan signals to the first and second pixels after the simultaneously transferring the second scan signal.

In an exemplary embodiment, an activating period of the first scan signals applied to the different first scan lines connected to the first and second pixels in the frame may not overlap an activating period of the second signal in the frame.

In such embodiment, an echo phenomenon due to a threshold voltage difference compensation of the driving transistor and a response speed is substantially reduced or effectively prevented.

In such embodiments, a dead space of a panel may be reduced by decreasing an area occupied by a driver for initializing a driving transistor in each pixel.

### BRIEF DESCRIPTION OF THE DRAWINGS

The above and other features of the invention will become more apparent by describing in further detail exemplary embodiments thereof with reference to the accompanying drawings, in which:

FIG. 1 is a block diagram illustrating an exemplary embodiment of an organic light emitting diode display according to the invention;

FIG. 2 is an equivalent circuit diagram of an exemplary embodiment of a pixel PX of the organic light emitting diode display in FIG. 1;

FIG. 3 is a signal timing diagram illustrating an exemplary embodiment of a driving method of an organic light emitting diode display according to the invention; and

FIG. 4 is a signal timing diagram illustrating an alternative exemplary embodiment of a driving method of an organic light emitting diode display according to the invention.

### DETAILED DESCRIPTION

The invention will be described more fully hereinafter with reference to the accompanying drawings, in which exemplary embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on,” “connected to” or “coupled to” another element or layer, the element or layer can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be described in further detail with reference to the accompanying drawings.

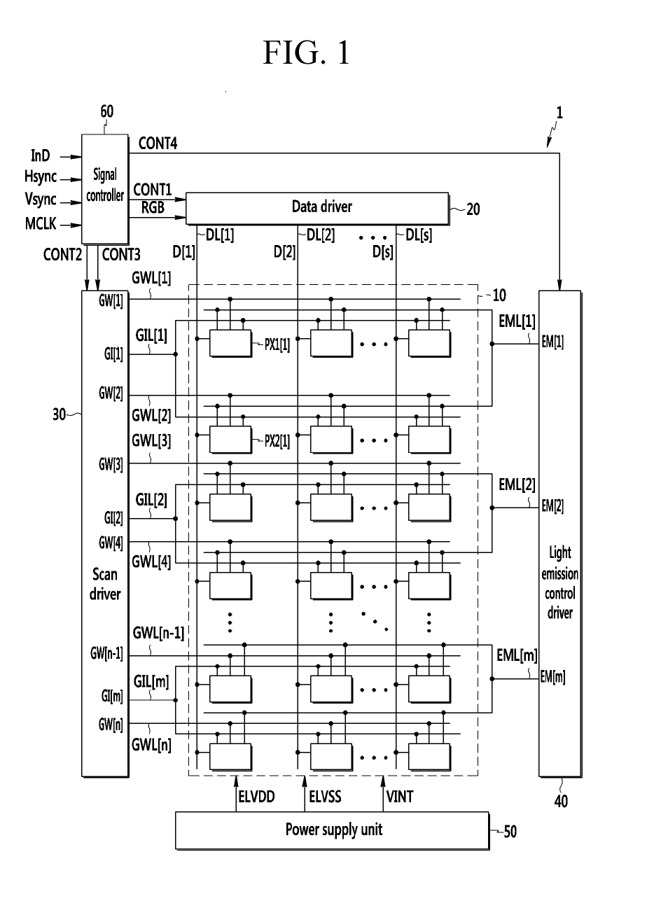

FIG. 1 is a block diagram illustrating an exemplary embodiment of an organic light emitting diode display according to the invention.

Referring to FIG. 1, an exemplary embodiment of an organic light emitting diode display 1 includes a display unit 10, a data driver 20, a scan driver 30, a light emission control driver 40, a power supply unit 50 and a signal controller 60. In such an embodiment, the display unit 10 includes a plurality of pixels PX, which is disposed in a display area thereof, and a plurality of first scan lines, e.g., first to n-th first scan lines GWL[1]-GWL[n], a plurality of second scan lines, e.g., first to m-th second scan lines GIL[1]-GIL[m], a plurality of data lines, e.g., first to s-th data lines DL[1]-DL[s], and a plurality of light emission control lines, e.g., first to m-th light emission control lines EML[1]-EML[m]. Here, each of n, m and s is a natural number greater than 1.

The plurality of pixels PX is arranged substantially in a matrix form including a plurality of pixel columns and a plurality of pixel rows. The plurality of first and second scan lines GWL[1]-GWL[n] and GIL[1]-GIL[m], and the plurality of light emission control lines EML[1]-EML[m] are disposed substantially parallel to each other and extend substantially in a pixel row direction, and the plurality of data lines DL[1]-DL[s] are disposed substantially parallel to each other and extend substantially in a pixel column direction.

In an exemplary embodiment, each of the plurality of pixels PX is connected to a corresponding first scan line among the plurality of first scan lines GWL[1]-GWL[n], and connected to a corresponding data line among the plurality of data lines DL[1]-DL[s]. Each of the plurality of pixels PX receives first and second power voltages ELVDD and ELVSS, and an initial voltage VINT from the power supply unit 50. In an exemplary embodiment, each of the plurality of pixels PX may include a red subpixel (not illustrated) that emits red light, a green subpixel (not illustrated) that emits green light, and a blue subpixel (not illustrated) that emits blue light.

In an exemplary embodiment, as shown in FIG. 1, adjacent pixels in a pixel column direction among the plurality of pixels PX are commonly connected to a corresponding second scan line among the plurality of second scan lines GIL[1]-GIL[m], and commonly connected to a corresponding light emission control line among the plurality of light emission control lines EML[1]-EML[m].

In such an embodiment, a plurality of first pixels PX1 connected to odd numbered first scan lines among the plurality of first scan lines GWL[1]-GWL[n] and a plurality of corresponding second pixels PX2 connected to even numbered first scan lines among the plurality of first scan lines GWL[1]-GWL[n] are commonly connected to the corresponding second scan lines and the corresponding light emission control lines. In an exemplary embodiment, as shown in FIG. 1, the first and second pixels PX1 and PX2 are connected to the odd numbered and even numbered first scan lines, respectively, but exemplary embodiments of the invention are not limited thereto. In an alternative exemplary embodiment, the first and second pixels PX1 and PX2 are connected to the even numbered and odd numbered first scan lines, respectively.

In one exemplary embodiment, for example, as shown in FIG. 1, the first pixel PX1[1] connected to the first first scan line GWL[1] and the second pixel PX2[1] connected to the second first scan line GWL[2] are commonly connected to a second scan line GIL[1]. In such an embodiment, the first and second pixels PX1[1] and PX2[1] are commonly connected to the first light emission control line EML[1].

In an exemplary embodiment, the data driver 20 processes image data RGB based on a data driving control signal CONT1 to generate a plurality of data signals, e.g., first to s-th data signals D[1]-D[s]. In such an embodiment, the data driver 20 may process the image data RGB to be suitable for a characteristic of the display unit 10 using the data driving control signal CONT1. The data driver 20 transfers the data signals D[1]-D[s] to the plurality of data lines DL[1]-DL[s] corresponding thereto.

In an exemplary embodiment, the scan driver 30 generates a plurality of first scan signals, e.g., first to n-th first scan signals GW[1]-GW[n], based on a scan driving control signal CONT2 and transfers the plurality of first scan signals GW[1]-GW[n] to corresponding first scan lines GWL[1]-GWL[n]. In such an embodiment, the scan driver 30 sequentially activates and transfers the plurality of first scan signals GW[1]-GW[n] corresponding to the plurality of first scan lines GWL[1]-GWL[n].

In an exemplary embodiment, the scan driver 30 generates a plurality of second scan signals, e.g., first to m-th second scan signals GI[1]-GI[m], based on an initial driving control signal CONT3 and transfers a plurality of second scan signals GI[1]-GI[m] to corresponding second scan lines GIL[1]-GIL[m].

The light emission control driver 40 generates a plurality of light emission control signals, e.g., first to m-th light emission control signals EM[1]-EM[m], based on a light emission control driving signal CONT4 and transfers the plurality of light emission control signals EM[1]-EM[m] to corresponding light emission control lines EML[1]-EML[m]. The power supply unit 50 generates the first power voltage ELVDD, the second power voltage ELVSS, and the initial voltage VINT.

In an exemplary embodiment, the signal controller 60 receives an external input data InD and a synchronization signal, and generates the data driving control signal CONT1, the scan driving control signal CONT2, the initial driving control signal CONT3, the light emission control driving signal CONT4, and the image data RGB. In such an embodiment, the synchronization signal includes a horizontal synchronization signal Hsync, a vertical synchronization signal Vsync, and a main clock signal MCLK.

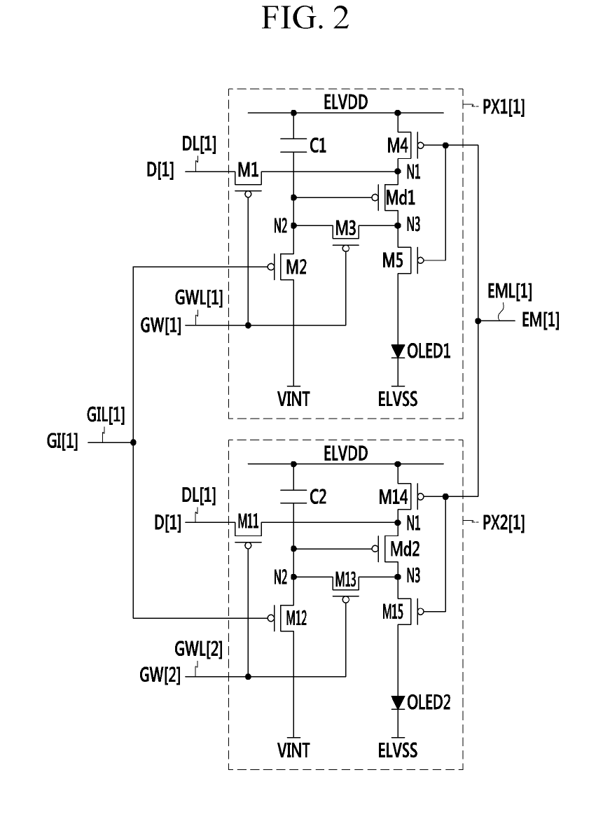

FIG. 2 is an equivalent circuit diagram of an exemplary embodiment of a pixel PX of the organic light emitting diode display of FIG. 1, e.g., a first pixel PX1[1] and a second pixel PX2[1] connected to a same second scan line.

Referring to FIG. 2, in an exemplary embodiment, the first pixel connected to a second scan line GIL[1], e.g., the first pixel PX1[1] connected to a first first scan line GWL[1] and a data line DL[1], includes a switching transistor M1, an initial transistor M2, a threshold voltage compensation transistor M3, first and second light emission control transistors M4 and M5, a driving transistor Md1, a capacitor C1, and an organic light emitting diode OLED1. In such an embodiment, the switching transistor M1 includes a first electrode connected to the data line DL[1] to receive the data signal D[1], a second electrode connected to a first node N1, and a gate electrode connected to the first first scan line GWL[1] to receive a first scan signal, e.g., a first first scan signal GW[1].

In such an embodiment, as shown in FIG. 2, the initial transistor M2 includes a first electrode connected to a second node N2, a second electrode which receives the initial voltage VINT, and a gate electrode connected to the second scan line GIL[1] to receive a second scan signal GI[1].

The threshold voltage compensation transistor M3 includes a first electrode connected to the second node N2, a second electrode connected to a third node N3, and a gate electrode connected to the first first scan line GWL[1] to receive the first first scan signal GW[1]. In such an embodiment, the first electrodes of the switching transistor M1, the initial transistor M2 and the threshold voltage compensation transistor M3 may be source electrodes, and the second electrodes of the switching transistor M1, the initial transistor M2 and the threshold voltage compensation transistor M3 may be drain electrodes.

The first light emission control transistor M4 includes a source electrode connected to a first power voltage ELVDD applying terminal, a drain electrode connected to the first node N1, and a gate electrode connected to a light emission control line EML[1] to receive the light emission control signal EM[1]. The second light emission control transistor M5 includes a source electrode connected to the third node N3, a drain electrode connected to an anode of the organic light emitting diode OLED1, and a gate electrode connected to the light emission control line EML[1] to receive the light emission control signal EM[1].

The driving transistor Md1 includes a source electrode connected to the first node N1, a drain electrode connected to the third node N3, and a gate electrode connected to the second node N2. The driving transistor Md1 supplies driving current corresponding to a voltage difference between the source electrode and the gate electrode to the organic light emitting diode OLED1.

The capacitor C1 includes a first terminal connected to the first power voltage ELVDD applying terminal, and a second terminal connected to the second node N2. The organic light emitting diode OLED1 includes a cathode connected to a second power voltage ELVSS applying terminal.

In an exemplary embodiment, a second pixel connected to the second scan line GIL[1], e.g., the second pixel PX2[1] connected to the second first scan line GWL[2] and the data line DL[1], includes a switching transistor M11, an initial transistor M12, a threshold voltage compensation transistor M13, first and second light emission control transistors M14 and M15, a driving transistor Md2, a capacitor C2, and an organic light emitting diode OLED2. In such an embodiment, a gate electrode of the switching transistor M11 of second pixel PX2[1] is connected to the second first scan line GWL[2] to receive the second first scan signal GW[2]. A connection relationship of the elements in the second pixel PX2[1] is substantially the same as the connection relationship of the elements in the first pixel PX2[1], and any repetitive detailed description thereof will hereinafter be omitted or simplified.

In an exemplary embodiment, as shown in FIG. 2, the first pixel PX1[1] and the second pixel PX2[1] simultaneously receive the second scan signal GI[1] and the light emission control signal EM[1]. Accordingly, in such an embodiment, the circuit configuration of the second scan driver 40 and the light emission control driver 50 is effectively simplified and thus a dead space of the organic light emitting diode display may be substantially reduced.

In an exemplary embodiment, the switching transistors M1 and M11, the initial transistors M2 and M12, the threshold voltage compensation transistors M3 and M13, the first and the second light emission control transistors M4, M5, M14 and M15, and the driving transistors Md1 and Md2 may include a P-type metal-oxide semiconductor (“PMOS”) transistor, but the invention is not limited thereto. In an alternative exemplary embodiment, at least one of the switching transistors M1 and M11, the initial transistors M2 and M12, the threshold voltage compensation transistors M3 and M13, the first light emission control transistors M4 and M14, the second light emission control transistors M5 and M15, and the driving transistors Md1 and Md2 may include an N-type metal-oxide semiconductor (“NMOS”) transistor.

In an exemplary embodiment, a connection relationship of the switching transistors M1 and M11, the initial transistors M2 and M12, the threshold voltage compensation transistors M3 and M13, the first light emission control transistors M4 and M14, the second light emission control transistors M5 and M15, the driving transistors Md1 and Md2, the capacitors C1 and C2, and the organic light emitting elements OLED1 and OLED2 is not limited to the connection relationship shown in FIG. 2, but may be variously modified.

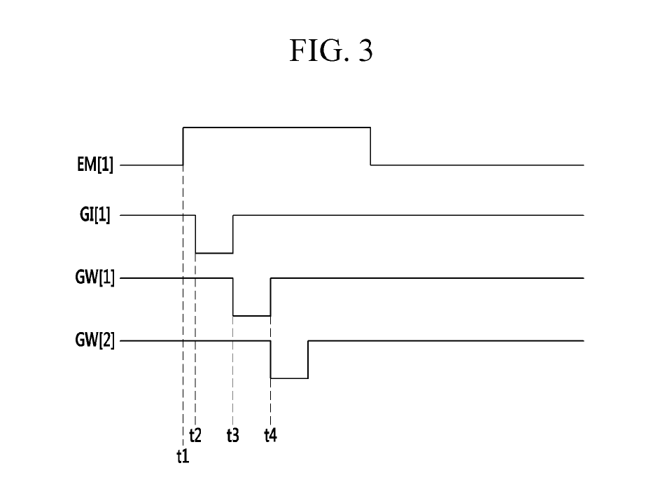

FIG. 3 is a signal timing diagram illustrating an exemplary embodiment of a driving method of an organic light emitting diode display according to the invention. Hereinafter, for convenience of description, an exemplary embodiment of a driving method of the organic light emitting diode display including the first pixel PX1[1] and the second pixel PX2[1] illustrated in FIG. 2 will be described.

Referring to FIGS. 2 and 3, in an exemplary embodiment, the light emission control signal EM[1] is inactivated at a first time point t1, and the first light emission control transistors M4 and M14 and the second light emission control transistors M5 and M15 are turned off at the first time point t1. In such an embodiment, the second scan signal GI[1] is transferred to the second scan line GIL[1] at a second time point t2 such that the initial transistor M2 of the first pixel PX1[1] is turned on, and the initial voltage VINT is applied to the second terminal of the capacitor C1 of the first pixel PX1[1].

Simultaneously, the initial transistor M12 of the second pixel PX2[1] is turned on, and the initial voltage VINT is applied to the second terminal of the capacitor C2 of the second pixel PX2[1]. As a result, a difference between gate-source voltages of each of the driving transistors Md1 and Md2 is maintained by a difference between the first power voltage ELVDD and the initial voltage VINT, and the voltage difference (e.g., ELVDD-VINT) may turn on the driving transistors Md1 and Md2 at a voltage greater than or substantially equal to a threshold voltage of each of the driving transistors Md1 and Md2. Accordingly, in such an embodiment, the driving transistors Md1 and Md2 are on-biased at substantially the same condition to display luminance corresponding to a data signal of a current frame such that the driving transistors Md1 and Md2 are effectively prevented from being influenced by a data signal written in a previous frame.

Next, the second scan signal GI[1] is inactivated, and the first first scan signal GW[1] is transferred to the first first scan line GWL[1] at a third time point t3, such that the switching transistor M1 and the threshold voltage compensation transistor M3 of the first pixel PX1[1] are turned on.

When the switching transistor M1 and the threshold voltage compensation transistor M3 of the first pixel PX1[1] are turned on, the data voltage corresponding to the data signal D[1] of the current frame is transferred to the source electrode of the driving transistor Md1 of the first pixel PX1[1] through the switching transistor M1, and the driving transistor Md1 of the first pixel PX1[1] is diode-connected by the threshold voltage compensation transistor M3. Accordingly, a voltage corresponding to a difference between the data voltage and the threshold voltage of the driving transistor Md1 of the first pixel PX1[1] is maintained at a node, e.g. the second note N2, connected to the second terminal of the capacitor C1.

Next, the second first scan signal GW[2] is transferred to the second first scan line GWL[2] at a fourth time point t4, such that the switching transistor M11 and the threshold voltage compensation transistor M13 of the second pixel PX2[1] are turned on.

When the switching transistor M11 and the threshold voltage compensation transistor M13 of the second pixel PX2[1] are turned on, a data voltage corresponding to the data signal D[1] of the current frame is transferred to the source electrode of the driving transistor Md2 of the second pixel PX2[1] through the switching transistor M11, and the driving transistor Md2 of the second pixel PX2[1] is diode-connected by the threshold voltage compensation transistor M13. Accordingly, a voltage corresponding to a difference between the data voltage and the threshold voltage of the driving transistor Md2 of the second pixel PX2[1] is maintained at the second node N2 connected to the second terminal of the capacitor C2.

Next, the light emission control signal EM[1] is transferred to the light emission control line EML[1], and the first light emission control transistors M4 and M14 and the second light emission control transistors M5 and M15 are turned on. When the first light emission control transistors M4 and M14 and the second light emission control transistors M5 and M15 are turned on, driving current corresponding to the data voltages stored in the capacitors C1 and C2 flows in the organic light emitting diodes OLED1 and OLED2, respectively, and the organic light emitting diodes OLED1 and OLED2 thereby emit light.

In an exemplary embodiment, driving current corresponding to the gate-source voltage difference of the driving transistor Md1 of the first pixel PX1[1] (e.g., ELVDD-Vd1, where Vd1 denotes the data voltage applied to the first pixel PX1[1]) flows in the organic light emitting diode OLED1 of the first pixel PX1[1], and driving current corresponding to the gate-source voltage difference of the driving transistor Md2 of the second pixel PX2[1] (e.g., ELVDD-Vd2, where Vd2 denotes the data voltage applied to the second pixel PX1[1]) flows in the organic light emitting diode OLED2 of the second pixel PX2[1]. In such an embodiment, the organic light emitting diodes OLED1 and OLED2 is controlled by the first light emission control transistors M4 and M14 and the second light emission control transistors M5 and M15, independently of the threshold voltages of the driving transistors Md1 and Md2, such that non-uniformity of luminance due to a threshold voltage difference is effectively prevented.

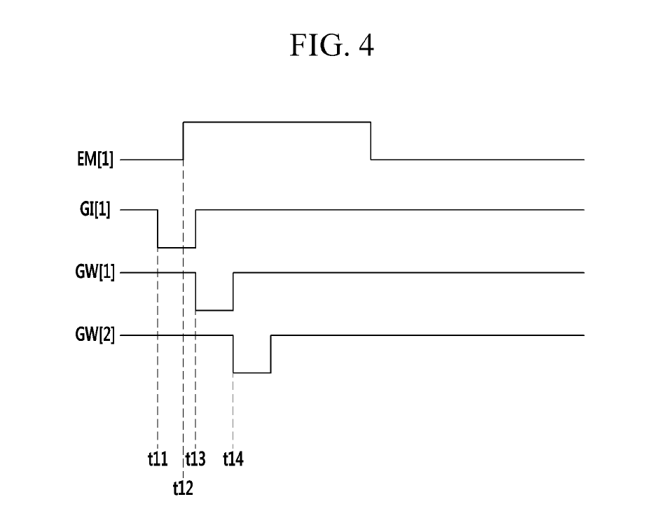

FIG. 4 is a signal timing diagram illustrating an alternative exemplary embodiment of a driving method of an organic light emitting diode display according to the invention. Hereinafter, for convenience of description, an alternative exemplary embodiment of a driving method of the organic light emitting diode display including the first pixel PX1[1] and the second pixel PX2[1] illustrated in FIG. 2 will be described.

Referring to FIGS. 2 and 4, at a first time point t11, the second scan signal GI[1] is transferred to the second scan line GIL[1] such that the initial transistors M2 and M12 are turned on, and the initial voltage VINT is applied to the second of the capacitors C1 and C2. As a result, a difference between gate-source voltages of each of the driving transistors is maintained by a difference between the first power voltage ELVDD and the initial voltage VINT.

In such an embodiment, the light emission control signal EM[1] is in an activated state at the first time point t11 such that the first light emission control transistors M4 and M14 and the second light emission control transistors M5 and M15 are in a turn-on state at the first time point t11. Accordingly, in the first time point t11 the organic light emitting diodes OLED1 and OLED2 emit light corresponding to the difference between the first power voltage ELVDD and the initial voltage VINT, instead of light corresponding to the data signal written in the previous frame. Thus, in such an embodiment, the first and second pixels PX1[1] and PX2[1], which are disposed to be adjacent to each other in a column direction, emit light at substantially the same luminance for a predetermined time before the data signal of the current frame is written.

In such an embodiment, the scan driver 30 sequentially transfers the plurality of light emission control signals EM[1]-EM[n] corresponding to the plurality of second scan lines GIL[1]-GIL[n], and the plurality of second scan signals GI[1]-GI[n] having activating periods that overlaps each other for a predetermined time. In such an embodiment, the activating periods of the plurality of second scan signals GI[1]-GI[n] may not overlap activating periods of the corresponding plurality of first scan signals GW[1]-GW[n]. Accordingly, in such an embodiment, when a text is rapidly scrolled on a screen in a column direction, a phenomenon of ghosting which causes a shadow may be effectively prevented.

In such an embodiment, the light emission control signal EM[1] is inactivated at a second time point t12, such that the first light emission control transistors M4 and M14 and the second light emission control transistors M5 and M15 are turned off. At a third time point t13, the second scan signal GI[1] is inactivated, and the first first scan signal GW[1] is transferred to the first first scan line GWL[1], such that the switching transistor M1 and the threshold voltage compensation transistor M3 of the first pixel PX1[1] are turned on.

As a result, the data voltage corresponding to the data signal D[1] of the current frame is transferred to the source electrode of the driving transistor Md1 of the first pixel PX1[1] through the switching transistor M1, and the driving transistor Md1 of the first pixel PX1[1] is diode-connected by the threshold voltage compensation transistor M3. Then, a voltage corresponding to a difference between the data voltage and the threshold voltage of the driving transistor Md1 of the first pixel PX1[1] is maintained at the second node N2 connected to the second terminal of the capacitor C1.

Next, at a fourth time point t14, the second first scan signal GW[2] is transferred to the second first scan line GWL[2], such that the switching transistor M11 and the threshold voltage compensation transistor M13 are turned on.

When the switching transistor M11 and the threshold voltage compensation transistor M13 are turned on, the data voltage corresponding to the data signal D[1] of the current frame is transferred to the source electrode of the driving transistor Md2 of the second pixel PX2[1] through the switching transistor M11, and the driving transistor Md2 of the second pixel PX2[1] is diode-connected by the threshold voltage compensation transistor M13. Then, a voltage corresponding to a difference between the data voltage and the threshold voltage of the driving transistor Md2 of the second pixel PX2[1] is maintained at the second node N2 connected to the second terminal of the capacitor C2.

Next, the light emission control signal EM[1] is transferred to the light emission control line EML[1], and the first light emission control transistors M4 and M14 and the second light emission control transistors M5 and M15 are turned on, such that driving current corresponding to the data voltages stored in the capacitors C1 and C2 flows in the organic light emitting diodes OLED1 and OLED2, respectively, and the organic light emitting diodes OLED1 and OLED2 thereby emit light.

While this invention has been described in connection with what is presently considered to be practical exemplary embodiments, it is to be understood that the invention is not limited to the disclosed embodiments, but, on the contrary, is intended to cover various modifications and equivalent arrangements within the spirit and scope of the appended claims.

What is claimed is:

1. An organic light emitting diode display, comprising:
a display unit comprising a plurality of data lines, a plurality of first scan lines, a plurality of second scan lines, a plurality of light emission control lines, and a plurality of pixels, wherein each of the plurality of pixels is connected to a corresponding data line of the plurality of data lines, a corresponding first scan line of the plurality of first scan lines, a corresponding second scan line of the plurality of second scan lines and a corresponding light emission control line of the plurality of light emission control lines;
a scan driver configured to transfer a plurality of first scan signals to the plurality of first scan lines, and transfer a plurality of second scan signals to the plurality of second scan lines, respectively;
a data driver configured to transfer a plurality of data signals to the plurality of data lines, respectively; and
a light emission control driver configured to transfer a plurality of light emission control signals to the plurality of light emission control lines, respectively,
wherein the scan driver transfers the plurality of second scan signals substantially simultaneously to at least two second scan lines among the plurality of second scan lines.

2. The organic light emitting diode display of claim 1, wherein
the plurality of pixels comprises first and second pixels connected to two first scan lines of the plurality of first scan lines, respectively, and commonly connected to a same second scan line of the plurality of second scan lines.

3. The organic light emitting diode display of claim 2, wherein
the first and second pixels are commonly connected to a same light emission control line of the plurality of light emission control lines.

4. The organic light emitting diode display of claim 1, wherein
the scan driver transfers a second scan signal of the plurality of second scan signals to have an activating period which overlaps an activating period of a corresponding light emission control signal of the plurality of light emission control signals for a predetermined time in a frame.

5. The organic light emitting diode display of claim 1, wherein
the scan driver activates a second scan signal of the plurality of second scan signals in a frame before a corresponding first scan signal of the plurality of first second signals is activated in the frame.

6. The organic light emitting diode display of claim 1, wherein each of the plurality of pixels comprises:
an organic light emitting diode;
a driving transistor configured to transfer a driving current to the organic light emitting diode based on a corresponding data signal applied thereto;
a capacitor comprising:
a first electrode connected to a first power voltage applying terminal; and
a second electrode connected to a gate electrode of the driving transistor;
a switching transistor configured to transfer the corresponding data signal to the second electrode of the capacitor based on a corresponding first scan signal applied thereto; and
an initial transistor configured to transfer an initial voltage to the second electrode of the capacitor based on a corresponding second scan signal applied thereto.

7. The organic light emitting diode display of claim 6, wherein
each of the plurality of pixels further comprises a threshold voltage compensation transistor which diode-connects the driving transistor based on the corresponding first scan signal applied thereto.

8. The organic light emitting diode display of claim 6, wherein each of the plurality of pixels further comprises:
a first light emission control transistor which connects the first power voltage applying terminal and the driving transistor based on a corresponding light emission control signal applied thereto; and
a second light emission control transistor which connects the driving transistor and the organic light emitting diode based on the corresponding light emission control signal applied thereto.

9. A driving method of an organic light emitting diode display, the driving method comprising:
substantially simultaneously transferring a light emission control signal of a plurality of light emission controls signals to first and second pixels of the organic light emitting diode display, which are disposed adjacent to each other and connected to different first scan lines of a plurality of first scan lines of the organic light emitting diode and to a same second scan line of a plurality of second scan lines of the organic light emitting diode, wherein the plurality of first scan lines transmits a plurality of first scan signals of the organic light emitting diode, and the plurality of second scan lines transfers a plurality of second scan signals of the organic light emitting diode; and
substantially simultaneously transferring a second scan signal of the plurality of second scan signals to the first and second pixels,
wherein the first and second pixels are connected to a data diver of the organic light emitting diode and receive a data signal, and
the first and second pixels receive an initial voltage for an activating period of the second scan signal in a frame.

10. The driving method of an organic light emitting diode display of claim 9, further comprising:
emitting light corresponding to a data signal of a previous frame written in each of the first and second pixels based on the light emission control signal.

11. The driving method of an organic light emitting diode display of claim 9, wherein
the substantially simultaneously transferring the second scan signal comprises transferring the second scan signal to have an active period which overlaps an activating period of the light emission control signal for a predetermined time in the frame.

12. The driving method of an organic light emitting diode display of claim 11, further comprising:
emitting light by the first and second pixels in response to the initial voltage.

13. The driving method of an organic light emitting diode display of claim 9, further comprising:
sequentially transferring different first scan signals to the first and second pixels after the simultaneously transferring the second scan signal.

14. The driving method of an organic light emitting diode display of claim 13, wherein
an activating period of the first scan signals applied to the different first scan lines connected to the first and second pixels in the frame does not overlap an activating period of the second signal in the frame.
